(19) United States
(12) Patent Application Publication
(10) Pub. No.: US 2025/0111459 A1
(43) Pub. Date: Apr. 3, 2025

(54) PREDICTING TAKEOVERS ACROSS MOBILITIES FOR FUTURE PERSONALIZED MOBILITY SERVICES

(71) Applicant: Honda Motor Co., Ltd., Tokyo (JP)

(72) Inventors: Zhaobo Zheng, Campbell, CA (US); Kumar Akash, San Jose, CA (US); Teruhisa Misu, San Jose, CA (US)

(73) Assignee: Honda Motor Co., Ltd., Tokyo (JP)

(21) Appl. No.: 18/581,829

(22) Filed: Feb. 20, 2024

Related U.S. Application Data
(60) Provisional application No. 63/587,255, filed on Oct. 2, 2023.

(51) Int. Cl. G06Q 50/26; G06N 3/042; G06Q 10/0637

(52) U.S. Cl. CPC G06Q 50/26; G06N 3/042; G06Q 10/0637

(57) ABSTRACT

A method for predicting takeover events across mobilities may monitor responses during takeover events in a car simulation from a plurality of participants. The method may monitor responses during takeover events in a micro-mobility simulation from the plurality of participants. The method may perform statistical analysis to find patterns and deviations between characteristics extracted from the responses during the takeover events in the car simulations and characteristics extracted from responses during the takeover events in the micro-mobility simulations. The method may form takeover predictions on a different type of micro-mobility vehicle using predictive modeling from the characteristics extracted from the responses during the takeover events in the car simulations and characteristics extracted from responses during the takeover events in the micro-mobility simulations. The method may integrate transfer learning in the predictive modeling.

### RELATED APPLICATIONS

This patent application is related to U.S. Provisional Application No. 63/587,255 filed Oct. 2, 2023, entitled “DualTake: Predicting Takeovers across Mobilities for Future Personalized Mobility Services”, in the names of the same inventors which is incorporated herein by reference in its entirety. The present patent application claims the benefit under 35 U.S.C § 119(e) of the aforementioned provisional application.

### BACKGROUND

To contribute to more sustainable and convenient future cities, more types of transportation may be needed in the future. For example, more micro-mobilities, such as e-scooter, mopeds, and e-bikes may be used. Micro-mobilities may be a promising urban transport alternative, particularly for its advantages on parking, first/last mile convenience, and short-distance travel. Micro-mobilities may have broader impacts on fuel efficiency and carbon emission, as a recent study has shown that E-scooters may have better emission and operation cost than internal combustion cars, hybrid cars, electric cars, and even public electrical buses. Micro-mobilities may be a good fit for the modern and future society because of health benefits. The transition from cars to electric micro-mobilities may lead to increase physical activity and prevent fatal accidents, which may outweigh air pollution exposure. With these advantages, social acceptance of mixed type of mobilities, as in shared mobilities or an integration of public transportation may emerge as an alternative for private cars.

Human machine interactions that relate to moment-to-moment control of the vehicle, and more recently, personalized experiences and driver state understanding may be an important aspect in current intelligent vehicles. As automated vehicles (AV) and automated driver assistive systems (ADAS) advance, the driver vehicle interaction may be important to driver trust, and acceptance. Besides research on driver fatigue, distraction, driving styles, and driver takeovers in AV may be critical because it is an interaction related to user trust. Takeover predictions through non-invasive in-vehicle sensors may improve user experiences.

Some systems may use eye movement, heart rate (HR), and galvanic skin response (GSR) to predict driver takeovers. These systems may build a deep neural network (DNN) to predict takeover intention, time, and quality, and may have accuracies of 96%, 93%, and 83%, respectively. Other systems may predict takeover performance in conditional automated driving vehicles. These systems may conduct the n-back memory task with gaze, physiological, and facial monitoring during conditional driving. In these systems, the model that may provide the best results may be random forest (RF), and it may have an area under the receiver operating characteristic curve (AUC) of 0.69. Another system took the driver reaction time to takeover request into a real-vehicle study. This system may utilize gaze movement in conditional automated driving, with a lead vehicle. This system may use linear regression models and found saccadic velocities, number of large saccades, and intercept to be significant for reaction time prediction. These existing systems may implicate the function development of driver monitoring and state detection in intelligent vehicles.

Existing systems may be limited in takeover prediction in cars because AV and ADAS development is generally focused on cars. Even for driver state understanding and affective computing in a broader term, most research is generally focused on cars. The future hybrid society may require the field to monitor driver states on multiple types of mobilities. However, many users may have not experienced micro-mobility before. For example, in 2019, there were only about 50 million e-scooter rides in the US. Even though there are no specific statistics on the number of users, it is still less than 0.15 e-scooter trips per capita in that year, compared to 84.1% of the US population that may be a licensed car driver. As a result, most users may still be novel to micro-mobility, with previous driving data only from cars. Thus, it may be desirable to provide driver monitoring services to these users on newer mobilities, by modeling their behaviors with data from traditional mobilities.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for predicting takeover events across mobilities is provided. The method may monitor responses during takeover events in a car simulation from a plurality of participants. The method may monitor responses during takeover events in a micro-mobility simulation from the plurality of participants. The method may further perform statistical analysis to find patterns and deviations between characteristics extracted from the responses during the takeover events in the car simulations and characteristics extracted from responses during the takeover events in the micro-mobility simulations. The method may form takeover predictions on a different type of micro-mobility vehicle using predictive modeling from the characteristics extracted from the responses during the takeover events in the car simulations and characteristics extracted from responses during the takeover events in the micro-mobility simulations. In addition, the method may integrate transfer learning in the predictive modeling.

According to another embodiment of the disclosure, a method for predicting takeover events across mobilities, the method implemented using a computer system including a processor communicatively coupled to a memory device is provided. The method may monitor responses during takeover events in a car simulation from a plurality of participants by monitoring eye movements, physiological readings, and body movements of the plurality of participants in the car simulation. The method may monitor responses during takeover events in a micro-mobility simulation from the plurality of participants by monitoring eye movements, physiological readings, and body movements of the plurality of participants in the micro-mobility simulation. The method may further perform statistical analysis to find patterns and deviations between characteristics extracted from the responses during the takeover events in the car simulations and characteristics extracted from responses during the takeover events in the micro-mobility simulations. The method may form takeover predictions on a different type of micro-mobility vehicle using predictive modeling using a feed forward deep neural network (DNN) from the characteristics extracted from the responses during the takeover events in the car simulations and characteristics extracted from responses during the takeover events in the micro-mobility simulations. The method may integrate transfer learning in the predictive modeling.

According to an embodiment of the disclosure, a method for predicting takeover events across mobilities is provided. The method may monitor responses during takeover events in a car simulation from a plurality of participants by monitoring eye movements, physiological readings, and body movements of the plurality of participants in the car simulation. The method may monitor responses during takeover events in a micro-mobility simulation from the plurality of participants by monitoring eye movements, physiological readings, and body movements of the plurality of participants in the micro-mobility simulation. The method may perform a Z-normalization on the characteristics extracted from the responses during the takeover events in the car simulations and the characteristics extracted from responses during the takeover events in the micro-mobility simulations. The method may further perform statistical analysis to find patterns and deviations between characteristics extracted from the responses during the takeover events in the car simulations and characteristics extracted from responses during the takeover events in the micro-mobility simulations. The method may further perform an ablation study to determine sensing modalities for takeover predictions on a different type of micro-mobility vehicle. The method may form takeover predictions on the different type of micro-mobility vehicle using predictive modeling using a feed forward deep neural network (DNN) from the characteristics extracted from the responses during the takeover events in the car simulations and characteristics extracted from responses during the takeover events in the micro-mobility simulations. The method may integrate transfer learning in the predictive modeling.

### BRIEF DESCRIPTION OF THE DRAWINGS

FIG. 1A is a perspective view of an exemplary motion-based mobility platform for an automobile, in accordance with an embodiment of the disclosure;

FIG. 1B is a perspective view of an exemplary motion-based mobility platform for a micro-mobility vehicle, in accordance with an embodiment of the disclosure;

FIG. 2A is a perspective view of an exemplary screen shot from the motion-based mobility platform for an automobile, in accordance with an embodiment of the disclosure;

FIG. 2B is a perspective view of an exemplary motion screen shot from the motion-based mobility platform for a micro-mobility vehicle, in accordance with an embodiment of the disclosure;

FIGS. 3A-3F are graphs displaying exemplary behavioral differences between automobiles and micro-mobility vehicles, in accordance with an embodiment of the disclosure;

FIG. 4 is a graph displaying exemplary target and source weight sum over boosting iterations, in accordance with an embodiment of the disclosure;

FIG. 5 is a graph displaying receiving operating characteristic (ROC) curves from different models, in accordance with an embodiment of the disclosure; and

FIG. 6 is a graph displaying area under the receiving operating characteristic (ROC) curves from different models, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The present disclosure provides takeover predictions on micro-mobilities with behavioral data from cars, through a deep neural network and transfer learning. This disclosure demonstrates the feasibility of across-mobility driver monitoring, without data collection necessities on the newer mobility.

Reference will now be made in detail to specific aspects or features, examples of which are illustrated in the accompanying drawings. Wherever possible, corresponding, or similar reference numbers will be used throughout the drawings to refer to the same or corresponding parts.

A hybrid society may be expected to emerge in the near future, with different mobilities interacting together, including cars, micro-mobilities, pedestrians, and delivery robots. Because of this, people may have more chances to utilize multiple types of mobilities in their daily lives. As automation in vehicles advances, driver modeling may become popular to provide personalized and intelligent services. Thus, modeling drivers across mobilities may pave the road for future society mobility-as-a-service and may be able to predict driver behaviors in newer mobilities with data from more traditional mobilities.

There is limited research on human machine interaction across mobilities. To get data for machine learning and analysis, one may need to conduct a user study on both car and micro-mobility simulations. In accordance with an embodiment, a study was conducted where one may be introduced to a micro-mobility, such as an e-scooter, and briefly showed the functionality and appearance of the e-scooter. A total of 48 participants were recruited in this study, with 28 males and 20 females. The participants were aged between 19 to 69, with an age mean of 33.8 years, and standard deviation of 11.7 years. There were participants who experienced too much motion sickness and withdrew from the study. New participants were added to replace them. The study was approved by the Institutional Review Board at ANONYMOUS.

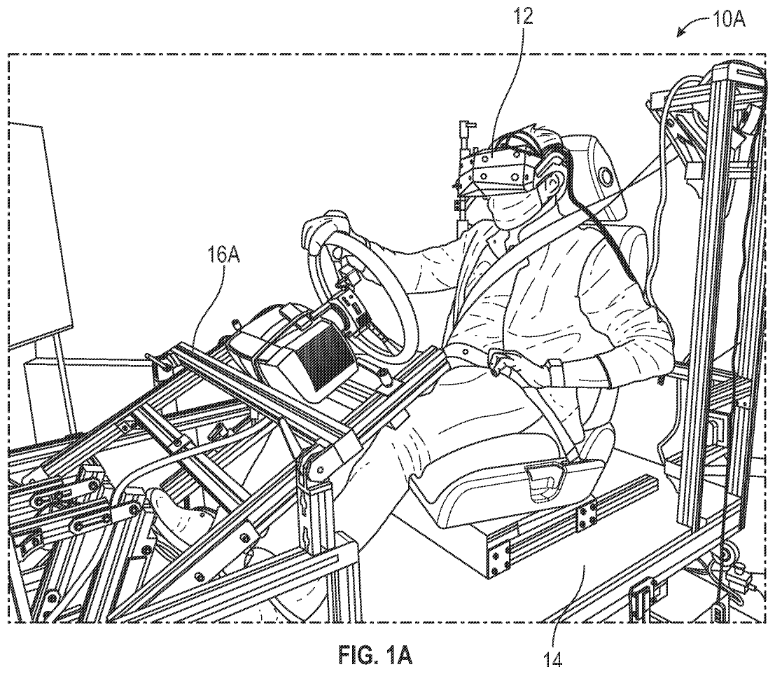

Referring to FIGS. 1A and 1B, to elicit natural responses from the participants, high-fidelity simulators 10A and 10B may be integrated for immersive experiences. A VR headset 12 may be used to incorporate a wide field-of-view (FoV), and a changing FoV with head movements of the participants. In accordance with an embodiment, a StarVR headset that has a 210-degree foV may be used. A motion base 14 that may have a 6 degree of freedom continuum robotic base, may be used to mimic vehicle motions to participants. Motions may include pushing forward when accelerating, tilting when turning, and nosing down when braking. Mobility platforms 16A, 16B may be mounted on the motion base 14. The mobility platform 16A may include a steering wheel, a throttle, and a brake pedal for the car (FIG. 1A), and a steering handle, a throttle and brake buttons for the micro-mobility (FIG. 1B).

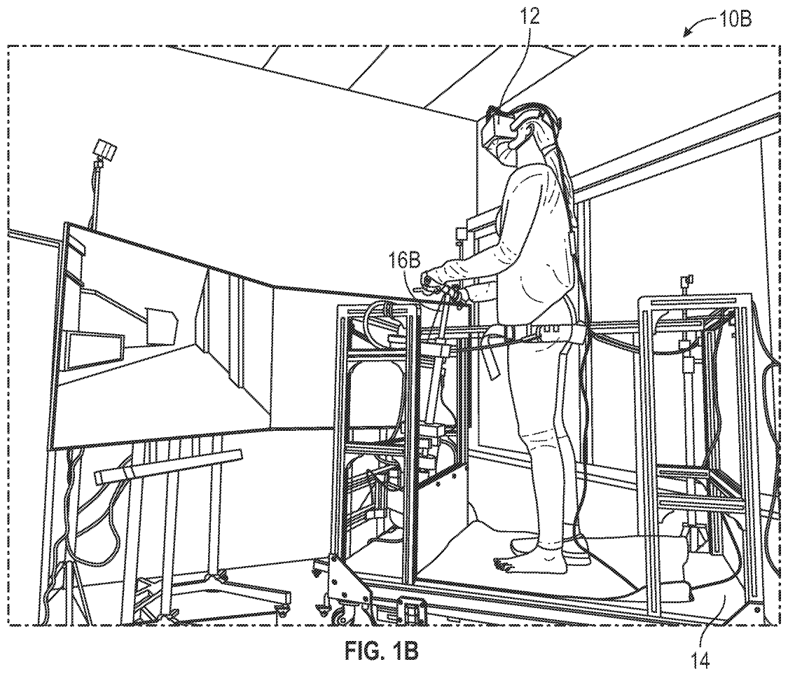

In the user study, participants may experience both the car and micro-mobility, in a counter-balanced order. The duration of the experiment may average around 1 hour 50 minutes in total. The simulation provided to the participants may be an urban driving environment, with road objects including pedestrians, cars, buildings, roads, sidewalks, trees, traffic lights, traffic signals, and stop signs. Some example scenarios for both mobilities may be shown in FIGS. 2A-2B.

The mobilities may be of Society of Automotive Engineers (SAE) Level 2 automation, with SAE Level 0 being fully manual to SAE Level 5 being fully autonomous. In accordance with an embodiment, SAE Level 2 may provide both longitudinal and latitude control, but the drivers may still need to monitor the automated drives at all times. The participants in the study may be asked to monitor the automated drives and takeover when they deemed necessary, with brake, or throttle inputs. Takeovers from the participants may not affect the automated drives, however, the takeovers may be monitored and recorded. The automated driving may be simulated by replaying a researcher's drive through the “Wizard of Oz” technique. In accordance with an embodiment, the video and audio may be rendered with Unreal Engine 4.24 and AirSim. These automated drives may be pre-recorded. The pre-recorded audio, visual and motion stimuli may be provided to the participants with a custom program in Unity. The stimuli may be synchronized so that motion happened at the right times during the driving simulation. The AV may have driving styles ranging from aggressive and defensive, as well as proactive and not proactive. The AV may provide some audio alert to the participant of its intentions under proactive mode, such as “waiting for pedestrian to pass”.

A multimodal sensing framework 18 (FIG. 1A and FIG. 1B) may be used to capture driver behaviors. The multimodal sensing framework 18 may have eye movement sensors, physiological sensors, as well as other body monitoring sensors. In accordance with an embodiment, the sensors may include eye gaze tracking with a StarVR headset, a Shimmer physiological sensor, and an E4 wristband. The StarVR headset may integrate the Tobii eye tracking IR-LED and camera to capture eye movements, and pupil information. The Shimmer GSR+ may have a wrist strap connected to two electrodes on the fingers of the participants and may be worn on the non-dominant hand of the participants. The E4 wristband may have both Photoplethysmography (PPG) and GSR measurements and may be worn on the dominant hand of the participants. One may apply both GSR+ and E4, which may provide better physiological quality on the GSR signals.

Of the 48 participants from the experiments, 42 participants had complete data from all modalities. The missing data may be due to sensor malfunctioning or manual operation mistakes, such as physiological sensor recording issues and eye tracking freezes. One may then synchronize the signals from different modalities and apply a nearest-neighbor interpolation on short interval null signals. These null signals may be mainly due to blinks. To eliminate the physical individualized differences, one may perform a Z-normalization as shown in equation (1) below.

$$Z ( x ) = \frac{x - μ}{σ} \qquad ( 1 )$$

Different features may be extracted to capture driver behaviors. In accordance with an embodiment, a total of 52 features may have been extracted as shown in Table 1 below.

TABLE 1
Feature List

| Data Modality | Count | Features |
|---|---|---|
| GSR | 5 | GSR* SCR_{count} |
| HR | 5 | HR* HRV |
| Eye gaze | 9 | x_{gaze}* y_{gaze}* entropy_{region} |
| Gaze Semantics | 15 | p_{objects} entropy_{object} |
| Maneuver | 4 | steering* |
| CAN-Bus | 14 | vₓ* v_{y}* w_{z}* Aggressiveness Proactive |

One may utilize the flowing window method, with a window length of 10 seconds without window coincidence. A complete sample may consist of features computed within each time window, and a label of whether the participants had a takeover 3 seconds after the time window. A takeover may be defined as a press on the brake or the throttle, as the participant may have been instructed to do. One may filter out peddle inputs that are less than 0.2 degrees to filter out noises. An asterisk means that one may have extracted the mean, standard deviation, minimum, and maximum values as 4 separate features. For peripheral physiological signals, one may compute the statistical features of the skin conductance level and the heart rate level. One may also extract the skin conductance response episode counts, and heart rate variations, which may be highly correlated with human arousal and stress. The StarVR headset gaze tracking may provide the segment of the scene in the 360 video and the gaze 2d position in that specific segment. Thus, one may compute the 2d gaze in the 360 videos. One may also segment the 360 frames into 9 different regions, such as top left, and middle right regions. Then, one may compute the gaze region entropy to estimate the degree of focus of the participant's gaze. Existing research demonstrates that the object people may be looking at may be equal or more important than the region on which they are focusing. Therefore, one may extract the semantic segmentation of each frame of the 360 videos, and compute what object the participants may be looking at. One may give higher weight to smaller but more important objects, such as pedestrians and traffic signals. One may also compute the gaze entropy for objects. Both types of entropy may be computed by the same equation as shown in equation 2 below.

$$H = {\sum }_{i = 1}^{n} {p}_{i} {log}_{2} {p}_{i} \qquad ( 2 )$$

One may extract the statistical features of the steering angle inputs from the participants. It should be mentioned that in an embodiment, the driving simulator steering wheel may have a motor that may rotate when the AV is making turns. One may compute the difference between the system output and the encoder reading of the steering wheel, which may be how much the participants turned the steering wheel. For CAN-Bus data, one may compute the statistical features of the linear velocities on the vehicle, in both the north-south and east-west directions on the 2D map, and the angular velocity. One may also include the aggressiveness of the vehicle, and whether it was proactive or not.

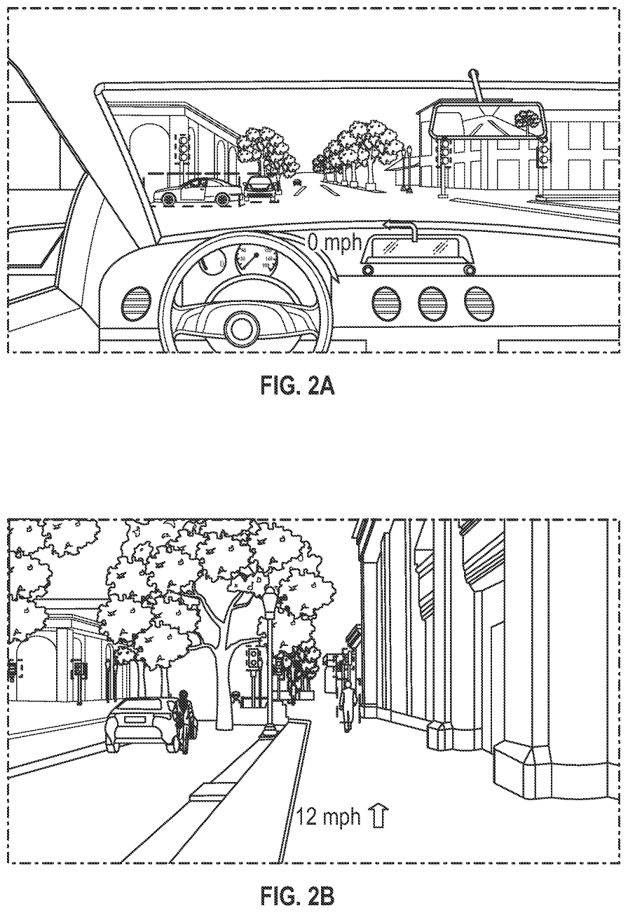

To introduce some different characteristics across the mobilities, one may conduct a statistical analysis. One may perform a paired t-test on the extracted features and find statistical significance on many features. One may visualize some of the representing results, as shown in FIG. 3. First, one may observe higher HR level mean (FIG. 3A) (p<0.001) and GSR maximum level (FIG. 3B) (p=0.039) on micro-mobility. In accordance with an embodiment, the participants sat in the car while they stood on the micromobility. The increased physical activity in the micro-mobility may have led to this peripheral physiological difference. Then, it may be found that the minimum gaze position (FIG. 3C) may be higher in the micro-mobility (p=0.007). From FIG. 1, it may be seen that the cabin may be blocking some parts of the scene while the micro-mobility almost has a free FoV. Participants may have focused more on the lower regions of the scenes because of the cabin. Similarly, significant differences may be found on object fixations (FIGS. 3D-3E). Participants in micro-mobility may have more fixation on people, and most did not pay attention to people in cars (p<0.001). Micro-mobility generally travelled on the sidewalk and there may be more interaction, and closer distance with other pedestrians. It may be worth noticing that significant object fixation difference may also be found in fixation on road (p<0.001), sidewalk (p<0.001), and road signs (p=0.049). As a result, object entropy may also be different across the mobilities (p=0.027), that participants may have fixation on fewer objects in micro-mobility. The reason may be that micro-mobility has a slower speed so the participants could focus on objects for longer period of time. Participants may have higher standard deviation on steering inputs (FIG. 3F) in the car (p<0.001). This may result from the faster travel speed of the car. The CAN-Bus features may also be different across mobilities due to faster car speed. The many behavioral differences across mobilities may be key factors to make prediction task challenging. People naturally behave differently on an entirely different platform, with different physical poses, surrounding environments, and travel speeds.

In total, in the current embodiment, one may have 142321 samples, with 55791 samples from the micromobility and 86530 samples from the car. The car simulation may have more samples due to the videos being longer. One may use the car samples as training and the micro-mobility samples as test, because in our current society, cars are a more popular mobility than micro-mobility. One may want to build a driver profile for a newer mobility. Takeover in AV may be a natural rare case, because too many takeovers may lead to rejection of such AV or ADAS features. In the present embodiment of the training data, there may be 5930 samples with takeovers, which is 10.1% of the training size. The dataset may be imbalanced but the takeover percentage may be much higher than many existing driving simulator studies. One may speculate that the more immersive simulation experiences and high frequency of interactions with other road users may have led to a higher percentage of takeovers. To address the imbalance problem of the present embodiment of training data, one may down-sample the major class to make a perfectly balanced training set. The reason one may use down-sampling is because it outperforms other popular balancing methods like Synthetic Minority Over-sampling Technique (SMOTE) on the baseline model.

In takeover prediction literature, Random Forest (RF) may outperform other models in many cases, potentially because of its efficiency on smaller datasets, and the ability to adapt to multimodal signals. One may use the RF as a baseline model for this binary prediction task. One may use the Scikit-learn library to build the classifier and run a grid search on parameters to improve the performance. The resulting best-performing RF classifier may have an accuracy of 0.787 and an AUC value of 0.595.

Dual-take is a feed-forward DNN, built with the Tensorflow Keras library. The network structure may start with an input layer length 54 to match the input feature counts. There may be three hidden layers with 64, 32, and 16 ReLu units. Each layer may receive the input values from the prior layer and outputs to the next one. Then, one may put a 1D maxpooling layer to reduce the spatial size and reduce over-fitting, followed by a dropout layer with a rate of 0.1. The network may utilize a binary cross entropy, and an Adam optimizer with a learning rate of 0.001. Dual-take may be trained for 20 epochs with a batch size of 16, using a mini-batch stochastic gradient descent. The Dualtake DNN model may have an accuracy of 0.856, and an AUC value of 0.741.

Future applications may be able to utilize car data to predict behaviors in newer mobilities. But it may also be interesting to compare the performance the other way around. One may train the Dual-Take with micro-mobility data as training, and car data as test. The resulted accuracy may be 0.871 and an AUC value of 0.595. The potential reasons for the AUC difference may include that less samples in the micro-mobility data were taken. Also, interactions from the car may have more scenarios and thus more versatile, such as yielding to pedestrian, and cars, while micro-mobility interaction may be less diverse, that most takeovers are related to closer distance with other pedestrians.

From the statistical analysis above, one may see that drivers behave differently across mobilities. To bridge the gap between behaviors on different mobilities, one may integrate transfer learning in DualTake. One may utilize the TrAdaBoost algorithm, which is a supervised instances-based domain adaptation method. The algorithm may have weights for the source and target samples, which sum up to 1.

$${\sum }_{i = 1}^{n} {w}_{S} + {\sum }_{i = 1}^{m} {w}_{T} = 1 \qquad ( 3 )$$

Then the algorithm may fit an estimator on source and target labeled data with the source and target weights and compute the error vectors of training instances.

$${E}_{S} = L ( f ( {X}_{S} , {w}_{S} ) , {y}_{S} ) \qquad ( 4 )$$

$${E}_{T} = L ( f ( {X}_{T} , {w}_{T} ) , {y}_{T} ) \qquad ( 5 )$$

With the error, the algorithm may compute the total weighted error of target instances, as shown in equation 6.

$${E}_{T} = \frac{1}{{n}_{T}} {w}_{T}^{T} {E}_{T} \qquad ( 6 )$$

And the algorithm may finally update the source and target weights as the following.

$${w}_{S} = {w}_{S} {β}_{S}^{E} \qquad ( 7 )$$

$${w}_{T} = {w}_{T} {β}^{- 1} {E}_{T} \qquad ( 8 )$$

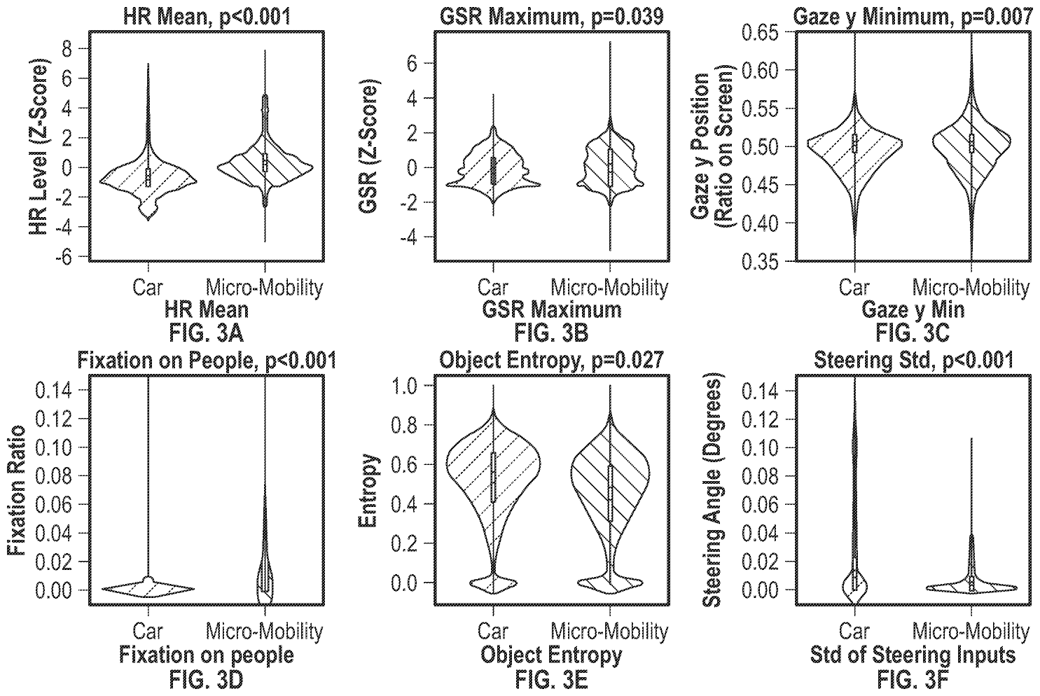

The algorithm may return to step 1 and loop until the number of boosting iteration may be reached. One may use a boost iteration of 10 with a learning rate of 0.5 for this TrAdaBoost algorithm. One may conduct a group-k-fold validation, which may be used for the car samples for the training source data. One may split the micro-mobility data into 5 folds by participants where each fold may contain certain participants. One may then use 4 folds of micro-mobility samples as training target data, with the remaining 1-fold as test data. In this cross-validation method, one may simulate the future application scenario, that one may pre-collect micro-mobility and car behavioral data from a certain number of participants, and one may want to predict takeovers from participants with car driving data, but they have not experienced micro-mobility before. For these new users, the present model may not use any of their micromobility data. The model reached an accuracy of 0.8612 and an AUV value of 0.7599. From the 5 DualTake TrAdaBoost models in the cross validation, one may compute the source and target weights for each iteration and sum up the weights for all the samples. One may visualize the weight on source and target data in FIG. 4. The TrAdaBoost algorithm may gradually shift weight towards target samples, and it may converge around 7 iterations, where the accuracy and AUC values may also converge. This result may indicate that target samples contain more important information about takeover predictions than expected. But the source data may also contribute to the prediction, potentially because the source data may contain the behavioral responses from the same participant.

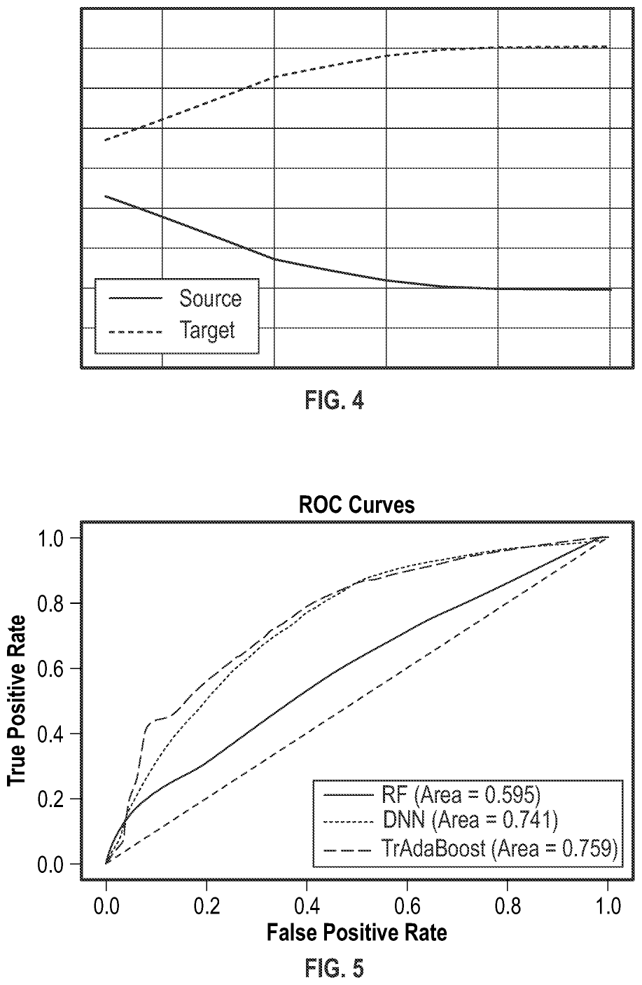

The receiving operating characteristic (ROC) curves from the baseline RF model, the DualTake DNN only, and the DualTake with TrAdaBoost may be seen in FIG. 5. The DualTake with TrAdaBoost may reach the best performance in the machine learning experiments. One may also list the performance of the present models with some existing work in takeover prediction, in Table 2 below. DualTake may predict takeovers across mobilities, and it may show comparable performance to most related existing work on single mobility.

TABLE 2
Feature List

| Model | Accuracy | AUC |
|---|---|---|
| RF baseline | 0.787 | 0.595 |
| DualTake DNN | 0.856 | 0.741 |
| DualTake TrAdaBoost | 0.8612 | 0.7599 |
| Du et al. | 0.85 | 0.69 |
| Pakdamanian et al. | 0.96 | 0.96 |

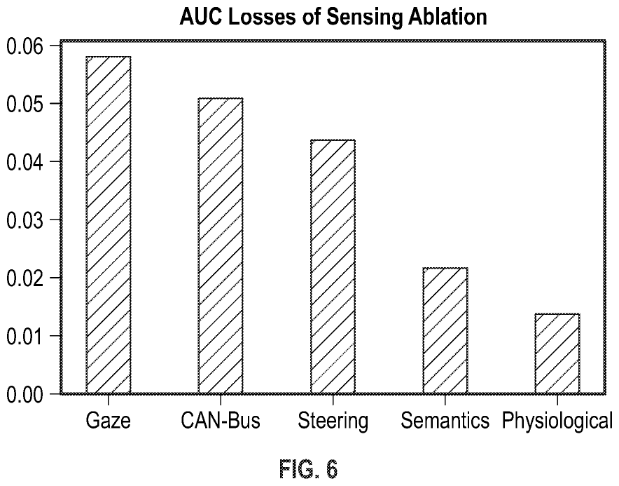

One may conduct an ablation study to recognize the most important sensing modalities for takeover prediction. One may take off the features from each sensing modality, train the DualTake model and assess the AUC values. One may compute the AUC loss as the metric of importance of each sensing modality. The results may be seen in FIG. 6. First, the AUC loss compared to existing research is not big for any of the sensing modalities, and the potential reason is that multimodal modeling may be making up the missing information, as a marker of multimodal enhancement. The more important modalities are gaze, CAN-Bus, and steering inputs, while semantics and physiological signals may be of less importance. The results may be very different from existing research, where CAN-Bus signals may be very dominant. One may hypothesize that there are big differences in CAN-Bus signals across mobilities, as shown in the statistical analysis. Thus, CAN-Bus signals may become more challenging for the domain transfer task, while other behaviors like gaze may be more universal for participants.

The present study developed a DNN and transfer learning-based model, DualTake, to predict driver's takeover across mobilities. In contrast to existing research that focuses on takeover prediction only in cars, the present study explored using behavioral data in traditional mobility to predict takeovers in newer mobility. The DualTake model reached an accuracy of 0.86 and an AUC value of 0.76. The promising performance of the present model demonstrates the application feasibility of personalized driver monitoring in future hybrid society. Users may be able to travel on different types of AVs and have a universal model to monitor and predict their behaviors. In addition, one may find more important sensing channels for such driver profiles, which may provide some design guidance for AV human machine interaction system applications.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims.

1. A method for predicting takeover events across mobilities, comprising:
monitoring responses during takeover events in a car simulation from a plurality of participants;
monitoring responses during takeover events in a micro-mobility simulation from the plurality of participants;
performing statistical analysis to find patterns and deviations between characteristics extracted from the responses during the takeover events in the car simulations and characteristics extracted from responses during the takeover events in the micro-mobility simulations;
forming takeover predictions on a different type of micro-mobility vehicle using predictive modeling from the characteristics extracted from the responses during the takeover events in the car simulations and characteristics extracted from responses during the takeover events in the micro-mobility simulations; and
integrating transfer learning in the predictive modeling.

2. The method of claim 1, comprising performing an ablation study to determine sensing modalities for the takeover predictions on the different type of micro-mobility vehicle.

3. The method of claim 1, wherein using predictive modeling comprises using a feed forward deep neural network (DNN).

4. The method of claim 1, wherein using predictive modeling comprises using a feed forward deep neural network (DNN) using a Tensorflow Keras library.

5. The method of claim 1, wherein integrating transfer learning in the predictive modeling comprises using a supervised instances-based domain adaptation method.

6. The method of claim 1, wherein integrating transfer learning in the predictive modeling comprises:
providing weighting values for source and target sample data;
computing error vectors of training instances;
computing total weighted error of target instances; and
updating the weighting values for the source and target sample data.

7. The method of claim 6, comprising repeating computing the error vectors of the training instances; computing the total weighted error of target instances; and updating the weighting values for the source and target sample data until a desired number of boosting iterations is reached.

8. The method of claim 1, comprising performing a Z-normalization on the characteristics extracted from the responses during the takeover events in the car simulations and the characteristics extracted from responses during the takeover events in the micro-mobility simulations.

9. The method of claim 1, wherein performing statistical analysis comprises performing a paired t-test on the characteristics extracted from the responses during the takeover events in the car simulations and characteristics extracted from responses during the takeover events in the micro-mobility simulations.

10. The method of claim 1, wherein the characteristics extracted from the responses during the takeover events in the car simulations are used as training sets and the characteristics extracted from responses during the takeover events in the micro-mobility simulations are used as test sets.

11. The method of claim 1, comprising downscaling one of the characteristics extracted from the responses during the takeover events in the car simulations or characteristics extracted from responses during the takeover events in the micro-mobility simulations to form balanced data sets.

12. The method of claim 1, wherein the car simulations and the micro-mobility simulations use a “Wizard of Oz” method.

13. The method of claim 1, comprising using multimodal sensing frameworks to monitor and record responses of the plurality of participants in the car simulation and the plurality of participants in the micro-mobility simulation.

14. The method of claim 11, wherein using the multimodal sensing frameworks comprises:
monitoring eye movements of the plurality of participants in the car simulation and the plurality of participants in the micro-mobility simulation;
monitoring physiological readings of the plurality of participants in the car simulation and the plurality of participants in the micro-mobility simulation; and
monitoring body movements of the plurality of participants in the car simulation and the plurality of participants in the micro-mobility simulation.

15. The method of claim 1, wherein the micro-mobility simulation is one of an e-scooter simulation, a moped simulation, or an e-bike simulation.

16. A method for predicting takeover events across mobilities, the method implemented using a computer system including a processor communicatively coupled to a memory device, the method comprising:
monitoring responses during takeover events in a car simulation from a plurality of participants by monitoring eye movements, physiological readings, and body movements of the plurality of participants in the car simulation;
monitoring responses during takeover events in a micro-mobility simulation from the plurality of participants by monitoring eye movements, physiological readings, and body movements of the plurality of participants in the micro-mobility simulation;
performing statistical analysis to find patterns and deviations between characteristics extracted from the responses during the takeover events in the car simulations and characteristics extracted from responses during the takeover events in the micro-mobility simulations;
forming takeover predictions on a different type of micro-mobility vehicle using predictive modeling using a feed forward deep neural network (DNN) from the characteristics extracted from the responses during the takeover events in the car simulations and characteristics extracted from responses during the takeover events in the micro-mobility simulations; and
integrating transfer learning in the predictive modeling.

17. The method of claim 16, comprising performing an ablation study to determine sensing modalities for the takeover predictions on the different type of micro-mobility vehicle.

18. The method of claim 16, wherein integrating transfer learning in the predictive modeling comprises:
providing weighting values for source and target sample data;
computing error vectors of training instances;
computing total weighted error of target instances; and
updating the weighting values for the source and target sample data.

19. The method of claim 18, comprising repeating computing the error vectors of the training instances; computing the total weighted error of target instances; and
updating the weighting values for the source and target sample data until a desired number of boosting iterations is reached.

20. A method for predicting takeover events across mobilities, comprising:
monitoring responses during takeover events in a car simulation from a plurality of participants by monitoring eye movements, physiological readings, and body movements of the plurality of participants in the car simulation;
monitoring responses during takeover events in a micro-mobility simulation from the plurality of participants by monitoring eye movements, physiological readings, and body movements of the plurality of participants in the micro-mobility simulation;
performing a Z-normalization on the characteristics extracted from the responses during the takeover events in the car simulations and the characteristics extracted from responses during the takeover events in the micro-mobility simulations;
performing statistical analysis to find patterns and deviations between characteristics extracted from the responses during the takeover events in the car simulations and characteristics extracted from responses during the takeover events in the micro-mobility simulations;
performing an ablation study to determine sensing modalities for takeover predictions on a different type of micro-mobility vehicle;
forming takeover predictions on the different type of micro-mobility vehicle using predictive modeling using a feed forward deep neural network (DNN) from the characteristics extracted from the responses during the takeover events in the car simulations and characteristics extracted from responses during the takeover events in the micro-mobility simulations; and
integrating transfer learning in the predictive modeling.
